(19) United States
(12) Patent Application Publication
(10) Pub. No.: US 2015/0235498 A1
(43) Pub. Date: Aug. 20, 2015

(54) COIN SORTING DEVICE WITH OVERFLOW COLLECTING DEVICE

(71) Applicant: WINCOR NIXDORF INTERNATIONAL GMBH, Paderborn (DE)

(72) Inventors: Harald LAUFHÜTTE, Heiligenhaus (DE); Eckhard EICK, Paderborn (DE); Erik TRUMPP, Feldafing (DE)

(21) Appl. No.: 14/622,669

(22) Filed: Feb. 13, 2015

(30) Foreign Application Priority Data
Feb. 14, 2014 (EP) 14 155 205.9

(51) Int. Cl. G07D 3/16

(52) U.S. Cl. CPC G07D 3/16

(57) ABSTRACT

A coin sorting device for processing coins comprises an insertion device into which coins for sorting are insertable, a sorting device for sorting coins inserted via the insertion device, a plurality of receiving containers for storing sorted coins, an overflow collecting device for receiving coins after at least one receiving container has overflowed, wherein coins for reinserting into the insertion device are removable from the overflow collecting device and are reinsertable into the insertion device in a reinserting operation, and a counting device for counting coins inserted into the insertion device and coins passing into the overflow collecting device. A checking device is provided which is designed to check whether, in the event of a reinserting operation, the number of coins reinserted into the insertion device corresponds to the number of coins removed from the overflow collecting device.

### CROSS-REFERENCE TO RELATED APPLICATION

This application claims priority to European Patent Application No. 14 155 205.9 filed on Feb. 14, 2014, the entirety of which is incorporated by reference herein.

### BACKGROUND

The invention relates to a coin sorting device for processing coins and to a method for operating such a coin sorting device.

A coin sorting device of this type comprises an insertion device into which coins for sorting can be inserted. The coin sorting device furthermore comprises a sorting device for sorting coins inserted via the insertion device, a plurality of receiving containers for storing sorted coins, and an overflow collecting device for receiving coins after at least one receiving container has overflowed. Coins for reinserting into the insertion device can be removed here from the overflow collecting device and reinserted into the insertion device in a reinserting operation. A counting device is designed for counting coins inserted into the insertion device and coins passing into the overflow collecting device.

With such a coin sorting device, coins can be sorted and can be dispensed again in a sorted manner for further use. The coins are inserted here via the insertion device into the coin sorting device, are sorted by means of the sorting device and conveyed into different receiving containers depending on their denomination. For example, one euro coins pass into a receiving container provided for one euro coins, two euro coins pass into a receiving container provided for two euro coins, etc. The coins can then be dispensed again in a sorted manner, for example packaged in coin rolls, via a suitable dispensing device.

If a receiving container is full, an overflow may occur at said receiving container should further coins be inserted into this receiving container. These further coins pass into the overflow collecting device which receives those coins which cannot be received (any more) because of an overflow at the individual receiving containers.

In this context, an overflow should be understood as meaning that, at a receiving container, a maximum level is reached, beyond which the receiving container cannot be filled, and therefore further coins cannot be inserted into the receiving container.

In the case of a coin sorting device known from EP 2 525 330 A1, coins are inserted via an insertion unit and are separated via a separation centrifuge. A conveying unit is arranged upstream of the separation centrifuge. A plurality of receiving containers for storing coins, into which coins are fed via a sorting unit, are located downstream of the separation centrifuge.

In the case of a coin sorting device known from U.S. Pat. No. 7,147,552, in order to separate coins, a conveyor device is provided in the form of a two-strand conveyor belt which forms a conveying section, along which coins are conveyed from an input container in an upward direction. Coins are conveyed into a coin collecting device in dependence on recognition, wherein objects not recognized as coins are sorted out and returned to a user.

In a coin sorting device of this type, coins which have been conveyed into the overflow collecting device can be removed again from the overflow collecting device and inserted in turn into the coin sorting device via the insertion device. If the receiving containers have been emptied in the mean time, the fresh insertion operation enables sorting and conveying of the coins into the respectively assigned receiving containers to take place.

The overflow collecting device conventionally generally consists of a collecting container into which coins drop when a receiving container has overflowed. The collecting container can be accessed, for example, via a drawer, and therefore coins can be removed from the overflow collecting device and fed in turn to the sorting device.

The fundamental problem arises here of preventing an unauthorized removal of coins from the overflow collecting device in order to prevent a theft of coins. If it is possible to access the coins contained in the collecting container without any check and, in particular, it cannot be checked whether and to which extent coins are removed from the collecting container, it is possible that an unauthorized removal of coins from the overflow collecting device may not be avoided.

### SUMMARY

It is an object of the present invention to provide a coin sorting device and a method for operating a coin sorting device, with which the security is increased in a simple, cost-effective manner, in particular by unauthorized removal of coins from the overflow collecting device not being readily possible.

This object is achieved by a coin sorting device with the features as described herein.

According thereto, a checking device is additionally provided which is designed to check whether, in the event of a reinserting operation, the number of coins reinserted into the insertion device corresponds to the number of coins removed from the overflow collecting device.

In particular, it can be provided that, for a reinserting operation, the coins located in the overflow collecting device are removable only in their entirety from the overflow collecting device and otherwise, for example if a user removes only some of the coins located in the overflow collecting device, a warning indication or alarm is generated.

The checking device serves to check whether the number of reinserted coins corresponds to the number of coins removed from the overflow collecting device. The checking device determines that all of the coins removed from the overflow collecting device are also inserted again into the insertion device, and it is thus ensured that all of the coins removed have also been fed again to the coin sorting device and no coins have been stolen. It is therefore ensured in a verifiable manner that all of the coins which have been removed are also completely inserted again into the insertion device such that an unnoticed theft of coins is at least made difficult, if not even impossible. If the checking device determines that the number of coins reinserted into the insertion device does not correspond to the number of coins removed from the overflow collecting device, this indicates an (unauthorized) theft of coins, which theft can be correspondingly registered and indicated and assigned to a user registered at the coin sorting device.

The counting device serves for counting the coins passing into the coin sorting device. The counting device here is advantageously designed in order to detect and to register the stocks in the coin sorting device at any time such that the number of coins in the various receiving containers and in the overflow collecting device are known at any time.

The counting device has a suitable sensor arrangement for detecting the coins. The counting device and the checking device can be integrated in one another here, for example in the form of electronics, and can optionally be part of a control device for controlling the coin sorting device.

The overflow collecting device advantageously has a first container and a second container which can be used (in an alternating manner) for collecting coins.

The second container can be arrangeable, for example, in or on the first container, wherein the overflow collecting device is designed in such a manner that, with a second container arranged in or on the first container, after at least one receiving container has overflowed, coins are collected in the second container, and the second container with coins collected therein is removable from the first container.

The overflow collecting device is designed in particular in that, with a second container not arranged in or on the first container, after at least one receiving container has overflowed, coins are collected in the first container.

If the second container is located together with the first container in the overflow collecting device, coins are conveyed into the second container in the event of an overflow of at least one receiving container. The coins which can no longer be received in the receiving containers respectively assigned thereto can therefore be collected in the second container. If the coins collected in the second container are intended to be inserted in turn into the insertion device for fresh insertion into the coin sorting device, the second container can be removed from the overflow collecting device in order to fill the coins from the second container manually into the insertion device.

Owing to the fact that the coins passing into the overflow collecting device can be removed in their entirety, by removal of a container from the overflow collecting device, and inserted in turn into the insertion device, it can be ensured that the coins which have passed into the overflow collecting device have to be removed only in their entirety and completely fed in turn in a verifiable manner to the coin sorting device. This permits a check as to whether the removed coins have also been completely inserted again, and thereby opposes a theft of coins from the overflow collecting device which may be unprotected.

In particular, it is possible to count the coins which pass into the overflow collecting device, and therefore which number of which coins is located in the overflow collecting device is always known. When the second container is removed and when the coins are reinserted into the coin sorting device, the reinserted coins can then be counted anew. If the number of reinserted coins differs from the previously determined number of coins found in the second container, this indicates that coins have been stolen, which can be immediately registered and displayed in a suitable manner.

In particular against the background that a user generally has to be identified and authorized at the coin sorting device prior to use in order, for example, to access the overflow collecting device, it is thereby possible to assign a potential theft operation to a user, and therefore it can readily be determined during which use operation by which user a theft of coins has taken place, should a theft procedure have occurred.

In one specific refinement, the overflow collecting device can have a drawer which is movable relative to a housing of the coin sorting device along a pull-out direction and in or on which the first container and/or the second container are arrangeable. In a normal operating position, the drawer is pushed into the housing of the coin sorting device, and at least one of the containers is located on the drawer. In order to remove, for example, the second container, the drawer can be opened such that the second container can be accessed and the latter can be removed from the drawer.

Owing to the fact that two containers are provided, it can be ensured that all of the coins located in the second container can always be reinserted via the insertion device. If the receiving capacity of the insertion device is too small in order to receive all of the coins located in the second container in one insertion operation, the coins can be gradually inserted into the insertion device from the second container, wherein coins, after being sorted and processed in the coin sorting device, can optionally be collected in the first container which can likewise be arranged removably at the drawer.

The first container and the second container can preferably be stackable one inside the other. For example, the second container can be insertable into the first container, and therefore the second container can be arranged within the first container in the drawer.

However, it is also conceivable that the first container and the second container are not stackable but rather can be placed (merely) in an alternating manner into the drawer.

In this connection, it is also conceivable and possible for further containers, for example a third container, to be present, said container, in turn, being able to be arranged in or on the first container. Such a third container can be advantageous in order, when the second container is removed, to ensure that, as before, two containers are arranged in the drawer. The first container can therefore remain constantly in the drawer while the second and the third container can be placed into the first container and removed from the first container in an alternating manner.

The containers can have, for example, a general box shape and, for this purpose, can be designed in a box-shaped manner with lateral walls and a base. Coins can therefore be collected in the containers, wherein those coins which can no longer be received in the respectively assigned collecting containers during or after sorting drop into one of the containers of the overflow collecting device and are therefore collected there.

The object is also achieved by a method for operating a coin sorting device for processing coins, in which
coins are inserted into an insertion device for sorting,
a sorting device sorts the inserted coins,
sorted coins are conveyed into a plurality of receiving containers, and
an overflow collecting device receives coins after at least one receiving container has overflowed,
   wherein a counting device counts coins inserted into the insertion device and coins passing into the overflow collecting device, and coins for reinserting into the insertion device are removable from the overflow collecting device and are reinsertable into the insertion device in a reinserting operation. It is provided here that a checking device checks whether, in the event of a reinserting operation, the number of coins reinserted into the insertion device corresponds to the number of coins removed from the overflow collecting device.

With regard to advantages and advantageous refinements, reference will be made to the provisions set out previously with regard to the coin sorting device and which are applied analogously to the method.

In an advantageous refinement, the overflow collecting device has a first container and a second container which is arrangeable in or on the first container, wherein, with a second container arranged in or on the first container, after at least one receiving container has overflowed, the overflow collecting device collects coins in the second container, and the second container with coins collected therein can be removed from the first container.

Additionally, it can be provided that with a second container not arranged in or on the first container, after at least one receiving container has overflowed, coins are collected in the first container.

A reinserting operation for reinserting coins from the overflow collecting device into the insertion device of the coin sorting device can then proceed as follows:

First of all it can be provided that a user has to be authorized in relation to the coin sorting device. For this purpose, the coin sorting device can have, for example, a suitable reading apparatus, for example for reading an identification card or another identification sign, and therefore, after a successful authorization operation, the user's identity and the authorization thereof for using and operating the coin sorting device are determined.

After a successful authorization, a drawer in or on which the first container and the second container are arranged can then be released for opening, and therefore a user can access the overflow collecting device and the coins stored therein.

In order to feed the coins again to the coin sorting device for renewed sorting, the user removes the second container with the coins arranged therein, wherein the number of coins located in the second container is known and is stored in the system.

The user then inserts the coins contained in the second container into the insertion device and therefore feeds said coins in turn to the coin sorting device. The insertion operation does not necessarily have to take place here in one go. It is also conceivable and possible that, depending on the holding capacity of the insertion device, the user first of all pours some of the coins located in the second container into the insertion device and then, after the start of the processing of the coins, places further coins from the second container into the insertion device.

If an overflow occurs at one or a plurality of receiving containers, and therefore sorted coins cannot be introduced into the assigned receiving containers, the coins pass again into the overflow collecting device, but this time into the first container located in the drawer (because the second container has indeed been removed). The coins are therefore collected in the first container, wherein the counting device counts the coins inserted in total—i.e. the coins which are sorted and are fed to the receiving containers and also the coins passing into the overflow collecting device.

The number of reinserted coins is then compared with the stored number of coins which have been found in the second container. If there is a deviation, this is registered and may indicate a theft of coins from the second container, which can be unambiguously assigned to the user operating the coin sorting device. If there is no deviation—i.e. the number of reinserted coins coincides with the number of coins previously placed in the second container, it is thus ensured that all of the coins have been fed again to the coin sorting device, that is, no theft of coins has occurred.

The coin sorting device advantageously has a sensor arrangement which is designed to detect whether the drawer is open and at least one container is located in the drawer. It can thereby be ensured, for example, that a reinserting operation can be started only whenever the drawer is closed (again) and at least one container is located in the drawer.

In addition, the drawer can have an actuator which enables opening of the drawer only when a user is registered and authorized at the coin sorting device and which otherwise locks the drawer and therefore prevents opening. If a user is authorized, the user, for example via a suitable insertion command at a command insertion device, can open the drawer by means of actuation of the actuator such that said user can access the overflow collecting device and coins stored therein.

During further operation, the first container and the second container can then always be used in an alternating manner. If coins from the second container are reinserted, coins which overflow are collected in the first container arranged in the drawer. If, by contrast, coins from the first container are reinserted, coins which have overflowed are collected in the second container arranged instead of the first container in the drawer. The first container and the second container can therefore always be removed in an alternating manner with coins arranged therein, wherein the other container in each case is then placed into the drawer and the drawer is closed again for a renewed inserting operation.

### BRIEF DESCRIPTION OF THE DRAWINGS

The concept on which the invention is based will be explained in more detail below with reference to the exemplary embodiments illustrated in the figures.

FIG. 1 shows a view of a coin sorting device.

FIG. 2 shows a schematic view of the coin sorting device with functional components arranged therein.

FIG. 3 shows a schematic partial view of the coin sorting device, illustrating a drawer with containers, which are arranged therein, of an overflow collecting device.

FIG. 4 shows a schematic view of a reinserting operation of coins collected in the overflow collecting device into an insertion device of the coin sorting device.

FIG. 5 shows a schematic view of a reinserting operation using a further, third container.

FIG. 6 shows a schematic view of a container of the overflow collecting device.

### DETAILED DESCRIPTION

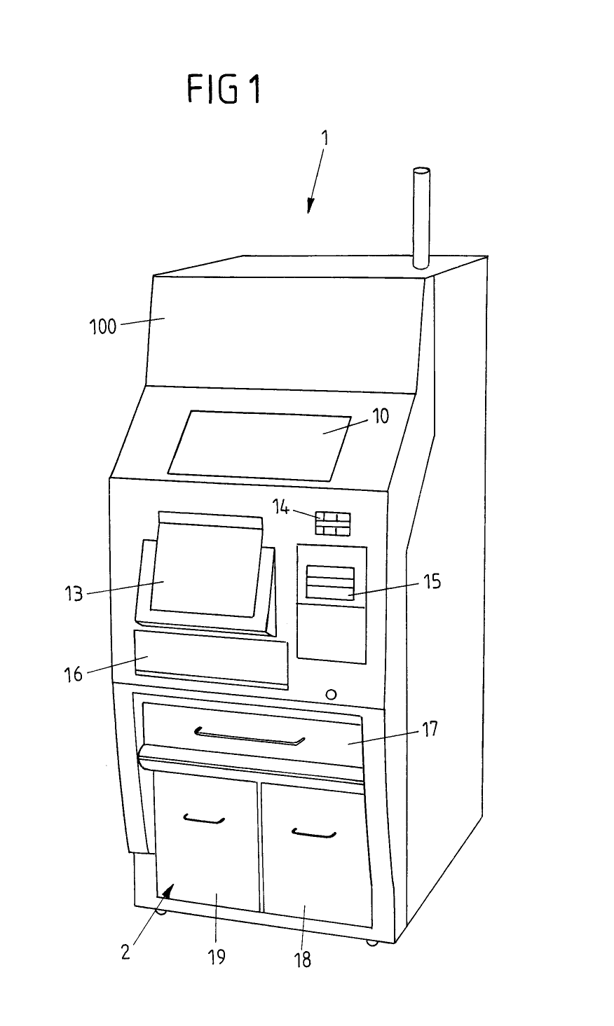

FIG. 1 shows, in a perspective overall view, a coin sorting device 1 which has a housing 100 in which various functional components of the coin sorting device 1 are arranged.

The coin sorting device 1 has an insertion device 10 in the form of a compartment closable by a flap, through which insertion device a user can insert coins into the coin sorting device 1 and can therefore feed the coins to the device for sorting. The coin sorting device 1 furthermore has a command input and display device 13 which can be designed, for example, as a touch-sensitive screen and via which, firstly, commands can be input by a user and, secondly, indications and possible inputs or the like can be displayed, and a reading apparatus 14 in the form of a card reader, via which a user can be identified by use of a suitable identification card and can thereby be authorized. A receipt dispensing device 15 is designed in order, after an insertion operation, to print and dispense a suitable receipt in order to give the user a receipt for the number of inserted coins and the value thereof and to display the correctness of the insertion operation. Coins or other objects, for example coins of a foreign currency or coin-like objects, can be returned to a user via a return compartment 16. Sorted coins can be dispensed via a dispensing compartment 17, wherein the dispensing compartment 17 can comprise, for example, a drawer into which sorted coins can be placed into different compartments such that, by removal of the drawer, a set of sorted coins, for example for use at a cash register device, can be obtained. A drawer 18 can have, for example, a container in the form of a transport container, into which coins can be conveyed, for example for transport. And a drawer 19 is part of an overflow collecting device 2 which will also be described below.

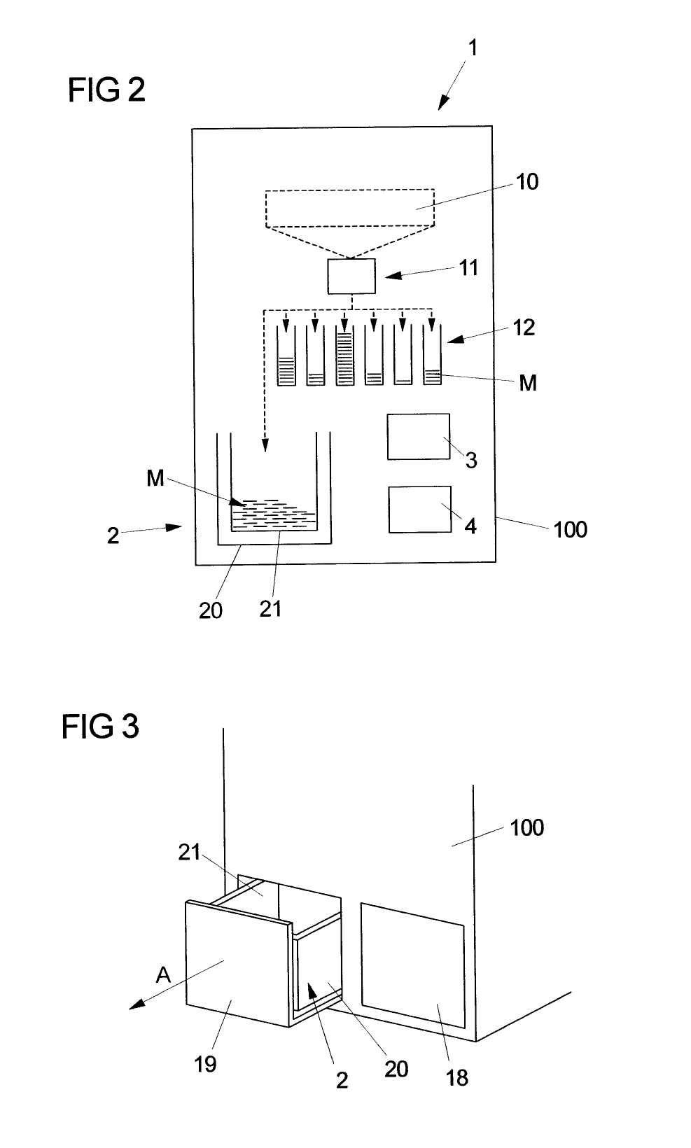

Functional components of the coin sorting device 1 are illustrated schematically in FIG. 2. A sorting device 11 which is designed in order to sort inserted coins M is arranged downstream of the insertion device 10. The sorting device 11 can be designed, for example, as a coin separating device in which coins M are separated, checked and fed to a collecting device having different receiving containers 12, in which the coins M can be stored and kept in a sorted manner in dependence on the denomination thereof. An orderly dispensing of sorted coins M, for example in the form of packaged coin rollers, can take place from the receiving containers 12 via the dispensing compartment 17.

Each receiving container 12 has a maximum holding capacity beyond which the receiving container 12 cannot receive any coins M. If a receiving container 12 is filled to the maximum and can therefore not receive any further coins M, an overflow occurs at this receiving container 12. Coins M which can no longer be received in an assigned receiving container 12 are fed to an overflow collecting device 2, and are collected and gathered there.

The overflow collecting device 2 has two containers 20, 21 which are arranged inserted one into the other on the drawer 19. A second container 21 is thus inserted into a first container 20 and is therefore accommodated by the latter, and therefore the containers 20, 21 can be arranged in a nested manner on the drawer 19. Suitable fixing means can be provided here on the drawer 19, by means of which the first, outer container 20 can be fixed in a releasable manner on the drawer 19 such that the containers 20, 21, when inserted into the drawer 19, are held on the drawer 19 in a defined manner.

In a normal operating state, the containers 20, 21 are located on the drawer 19, wherein the drawer 19 is pushed into the housing 100 of the coin sorting device 1. The containers 20, 21 are therefore surrounded by the housing 100 and are in a position in which, when a receiving container 12 overflows, coins M are conducted into the inner, second container 21 and are collected there, as is illustrated schematically in FIG. 2.

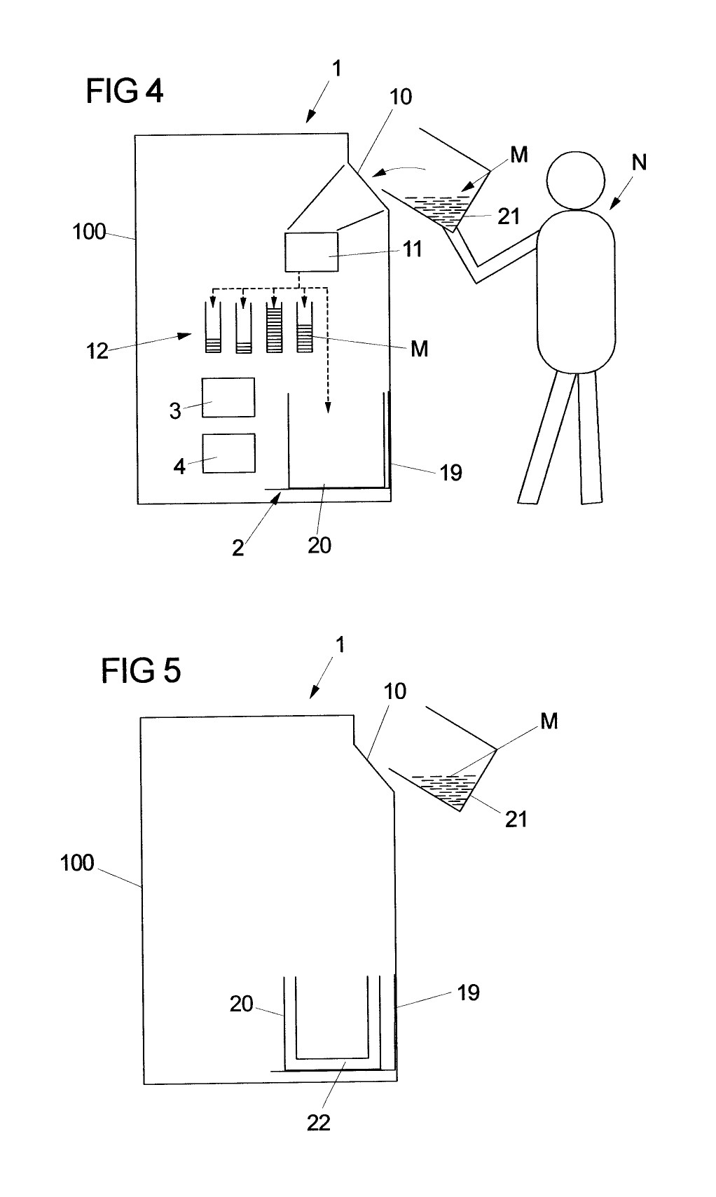

In order to remove coins from the overflow collecting device 2, the drawer 19 can be pulled out of the housing 100 of the coin sorting device 1 in a pull-out direction A (see FIG. 3) such that the containers 20, 21 arranged on the drawer 19 can be accessed. In particular, the second container 21, which is arranged in the first container 20, can be removed in its entirety together with coins M arranged therein, in order to pour the coins M again into the insertion device 10 and therefore to feed the coins again to the coin sorting device 1, as is illustrated schematically in FIG. 4.

As is apparent from FIG. 2, the coin sorting device 1 has, as a further functional component, a counting device 3 which serves to count coins M inserted into the coin sorting device 1, to detect the stocks in the receiving containers 12 and also to detect and count those coins M which pass into the overflow collecting device 2. The counting device 3 therefore ensures that the coins M stored in the receiving container 12 and also the number of coins M in the overflow collecting device 2 are always known.

If, as illustrated in FIG. 4, a user N removes the second container 21 with coins M arranged therein from the first container 20 of the overflow collecting device 2, the number of coins M located in the second container 21 is known. If the user N inserts the coins M stored in the second container 21 into the insertion device 10 again, the number of inserted coins M is again counted and compared by a checking device 4 with the known number of coins M previously located in the second container 21, and therefore it is checked whether all of the coins from the second container 21 are also inserted again into the insertion device 10 of the coin sorting device 1.

If this does not happen, this may indicate a theft of coins M from the second container 21, which can be correspondingly registered and displayed by the checking device 4.

Access to the drawer 19 with the containers 20, 21 located therein generally necessarily requires that a user N is previously identified and authorized at the coin sorting device 1 and, for this purpose, inserts, for example, a suitable identification card into the reading apparatus 14. Only then can, for example, an unlocking of the drawer 19 be made possible by inputting a suitable command at the command input and display device 13 and therefore access to the overflow collecting device 2 be permitted.

The user N who removes the second container 21 for the purpose of reinsertion into the coin sorting device 1 is therefore known to the coin sorting device 1. If, during a reinserting operation, an irregularity is therefore determined by the checking device 4, because, for example, the number of reinserted coins differs from the known number of coins M contained previously in the second container 21, this can be registered and assigned unambiguously to the user N. A user N can therefore not steal coins M from the overflow collecting device 2 undetected. Access to the overflow collecting device 2 is only possible for a user N when said user has been authorized in the system. If an irregularity then occurs during a comparison of the reinserted coins M with the known number of previously stored coins M, this is readily assignable to the respective user N.

Owing to the fact that the second container 21 can be removed as a whole, with all of the coins M stored therein, from the first container 20 and therefore the coins M located in the second container 21 can be poured in their entirety into the insertion device 10, it is possible to compare the number of inserted coins M with the number of coins M previously stored in the second container 21. When the coins M are inserted into the insertion device 10 and when the drawer 19 is in turn closed, the processing of the coins M can begin immediately, wherein the reinserted coins M are sorted and fed to the respective receiving containers 12 and, in the event of an overflow, coins are collected in the first container 20 of the overflow collecting device 2.

The first container 20 is also removable here from the drawer 19, and therefore, in the event of a renewed reinserting operation, the first container 20 can be removed and coins M can be reinserted via the latter into the coin sorting device 1. During further operation, the first container 20 and the second container 21 can therefore be used in an alternating manner for inserting and collecting the coins M.

It is also possible and conceivable to provide three containers 20, 21, 22, wherein the third container 22 is located in the first container 20 when coins M are reinserted via the second container 21. In this case, the second container 21 and the third container 22 can be used in an alternating manner and are in each case inserted in an operating state into the first container 20 for collecting coins M.

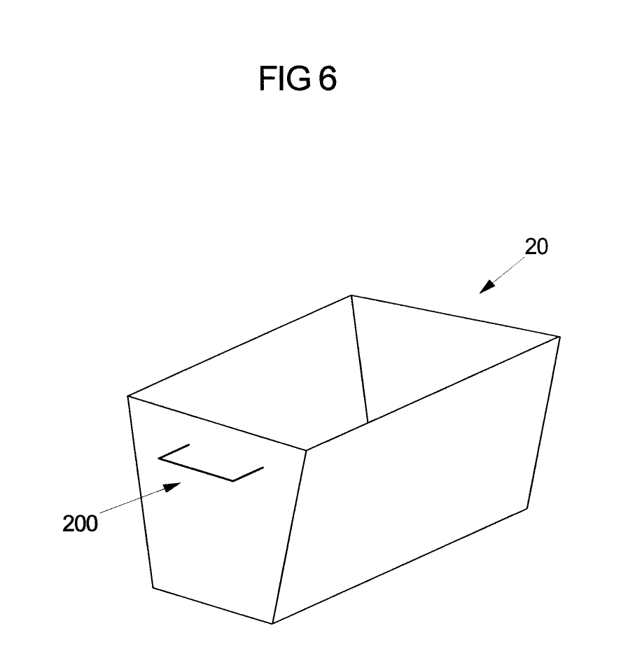

The containers 20-22 generally have a box shape, as is illustrated schematically in FIG. 6. Each container 20-22 here can have two handles 200 such that the container 20-22 is easily graspable and is removable from the drawer 19.

The concept on which the invention is based is not restricted to the exemplary embodiments described above, but rather can in principle also be realized in an entirely different manner.

### LIST OF REFERENCE SIGNS

1 Coin sorting device
10 Insertion device
100 Housing
11 Sorting device
12 Receiving container
13 Command input and display device
14 Reading apparatus
15 Receipt dispensing device
16 Return compartment
17 Dispensing compartment
18, 19 Drawer
2 Overflow collecting device
20 First container
200 Handle
21 Second container
22 Third container
3 Counting device
4 Checking device
A Pull-out direction
M Coins

1. A coin sorting device for processing coins, comprising
an insertion device into which coins for sorting are insertable,
a sorting device for sorting coins inserted via the insertion device,
a plurality of receiving containers for storing sorted coins,
an overflow collecting device for receiving coins after at least one receiving container has overflowed, wherein coins for reinserting into the insertion device are removable from the overflow collecting device and are reinsertable into the insertion device in a reinserting operation,
a counting device for counting coins inserted into the insertion device and coins passing into the overflow collecting device, and
a checking device which is designed to check whether, in the event of a reinserting operation, the number of coins reinserted into the insertion device corresponds to the number of coins removed from the overflow collecting device.

2. The coin sorting device according to claim 1, wherein, for a reinserting operation, the coins located in the overflow collecting device are removable only in their entirety from the overflow collecting device.

3. The coin sorting device according to claim 1, wherein the checking device is designed to produce an indication if it is determined during a reinserting operation that the number of coins reinserted into the insertion device does not correspond to the number of coins removed from the overflow collecting device.

4. The coin sorting device according to claim 1, wherein the overflow collecting device has a first container and a second container for collecting coins.

5. The coin sorting device according to claim 4, wherein the second container is arrangeable in or on the first container, wherein the overflow collecting device is designed in such a manner that, with a second container arranged in or on the first container, after at least one receiving container has overflowed, coins are collected in the second container, and the second container with coins collected therein is removable from the first container.

6. The coin sorting device according to claim 4, wherein the overflow collecting device is designed in such a manner that, with a second container not arranged in or on the first container, after at least one receiving container has overflowed, coins are collected in the first container.

7. The coin sorting device according to claim 4, wherein the overflow collecting device has a drawer which is movable relative to a housing of the coin sorting device along a pull-out direction and in or on which the first container and/or the second container are arrangeable.

8. The coin sorting device according to claim 7, wherein the first and/or the second container is removable from the drawer.

9. The coin sorting device according to claim 4, wherein the second container is insertable into the first container.

10. The coin sorting device according to claim 4, wherein the overflow collecting device has a third container which is arrangeable in or on the first container and/or the second container.

11. The coin sorting device according to claim 4, wherein the containers have a box shape.

12. A method for operating a coin sorting device for processing coins, in which
coins are inserted into an insertion device for sorting,
a sorting device sorts the inserted coins,
sorted coins are conveyed into a plurality of receiving containers, and
an overflow collecting device receives coins after at least one receiving container has overflowed,
wherein a counting device counts coins inserted into the insertion device and coins passing into the overflow collecting device, and coins for reinserting into the insertion device are removable from the overflow collecting device and are reinsertable into the insertion device in a reinserting operation, and
wherein a checking device checks whether, in the event of a reinserting operation, the number of coins reinserted into the insertion device corresponds to the number of coins removed from the overflow collecting device.

13. The method according to claim 12, wherein the overflow collecting device has a first container and a second container which is arrangeable in or on the first container, wherein, with a second container arranged in or on the first container, after at least one receiving container has overflowed, the overflow collecting device collects coins in the second container, and the second container with coins collected therein can be removed from the first container.

14. The method according to claim 13, wherein with a second container not arranged in or on the first container, after at least one receiving container has overflowed, coins are collected in the first container.

15. The method according to claim 13, wherein
a user is authorized in relation to the coin sorting device,
after authorization has taken place, a drawer, in or on which the first container and the second container are arranged, is released for opening,
the user removes the second container with a first number of coins arranged therein from the first container,
the user inserts coins contained in the second container into the insertion device in a reinserting operation,
after at least one receiving container has overflowed, coins are collected in the first container, and
the checking device checks whether the number of coins inserted in the insertion operation corresponds to the first number of coins.
